(19) United States
(12) Patent Application Publication
(10) Pub. No.: US 2023/0005225 A1
(43) Pub. Date: Jan. 5, 2023

(54) Cloud-based Production of High-Quality Virtual And Augmented Reality Video Of User Activities

(71) Applicant: Within Unlimited, Inc., Venice, CA (US)

(72) Inventors: Chris Milk, Los Angeles, CA (US); Aaron Koblin, Venice, CA (US)

(73) Assignee: Within Unlimited, Inc., Venice, CA (US)

(21) Appl. No.: 17/843,187

(22) Filed: Jun. 17, 2022

Related U.S. Application Data
(63) Continuation of application No. PCT/IB2021/050028, filed on Jan. 5, 2021.
(60) Provisional application No. 62/959,031, filed on Jan. 9, 2020.

(51) Int. Cl. G06T 19/00; G06T 19/20; G06V 40/20; G06F 3/01; G02B 27/01

(52) U.S. Cl. CPC G06T 19/006; G06T 19/20; G06V 40/20; G06F 3/014; G02B 27/0172

(57) ABSTRACT

A computer-implemented method includes obtaining first data, including telemetry data and beatmap synchronization data from a user device such as a virtual reality (VR) headset. The telemetry data relates to actions and/or movements of a person wearing the user device in a real-world environment. The telemetry data and beatmap synchronization data are used to produce one more video segments of a virtual person in a virtual world environment. The video production may take place in the cloud, away from the user device. The video production may include post-production and visual effects. The video production may be higher quality and/or resolution than images displayed in real-time on the user device.

### RELATED APPLICATION

This application is a continuation of PCT/IB2021/050028, filed Jan. 9, 2020, which claims the benefit of U.S. patent application No. 62/959,031, filed Jan. 9, 2020, the entire contents of both of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to virtual reality (VR), and, more particularly, to methods, systems and devices supporting production of video of user interactions in a VR environment.

### BACKGROUND

Virtual and augmented reality devices allow a user to view and interact with virtual environments. A user may, effectively, immerse themselves in a non-real environment and interact with that environment. For example, a user may interact (e.g., play a game) in a virtual environment, where the user's real-world movements are translated to acts in the virtual world. Thus, e.g., a user may simulate tennis play or bike riding or the like in a virtual environment by their real-world movements.

A user may see a view of their virtual environment with a wearable VR/AR device such as a virtual reality (VR) headset or augmented reality (AR) glasses or the like (generally referred to as a head-mounted display (HMD)). A representation of the VR user (e.g., an avatar) may be shown in the virtual environment to correspond to the VR user's location and/or movements.

While interacting in a VR environment, a user may see themselves or a representation (e.g., an avatar) in the VR environment. However, the user (and others) cannot see themselves from the viewpoint or perspective of a third person in the VR environment.

It is desirable, and an object of this invention, to provide users of VR/AR-based activities with videos or other images or the like showing their movements and activities in their VR environment.

It is further desirable and a further object of this invention to provide such videos and/or images from an arbitrary viewpoint or perspective in the VR environment.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented including (a) obtaining first data, said first data including: (i) telemetry data from a user device, the telemetry data relating to actions and/or movements of a person wearing the user device in a real-world environment, wherein the user device comprises a virtual reality (VR) headset, (iii) synchronization data, and (iii) object data relating to one or more virtual objects in a virtual-world environment.

The method also includes (b) analyzing the first data to recognize the actions and/or movements of the person in the real-world environment. The method also includes (c) mapping the actions and/or movements recognized in (b) of the person in the real-world environment to corresponding virtual actions and/or movements of a virtual person in the virtual world environment and relative to said virtual objects in the virtual world environment, the mapping using the synchronization data. The method also includes (d) rendering at least some of the virtual actions and/or movements of the virtual person in the virtual world environment relative to the virtual objects. The method also includes (e) producing one or more video segments of the virtual person in the virtual world environment as rendered in (d). Other embodiments of this aspect include corresponding computer systems, apparatus, and computer programs recorded on one or more computer storage devices, each configured to perform the actions of the methods.

Implementations may include one or more of the following features, alone or in combination(s):
the method where the one or more video segments may include a video; and/or
the method where the one or more video segments are produced from a corresponding one or more arbitrary viewpoints in the virtual world environment; and/or
the method where the one or more video segments may include a 360-video; and/or
the method where the first data are obtained in (a) while a first view of the virtual world environment is being displayed on a display of the VR headset; and/or
the method where the first view is produced at a first resolution, and where the one or more video segments are at a resolution higher than the first resolution; and/or
the method where the telemetry data are produced by and sent from the VR headset; and/or
the method where the user device also may include at least one VR handheld controller being worn by the person, and where the first data also includes data from the at least one VR handheld controller; and/or
the method where the virtual objects may include objects in a game or activity; and/or
the method where the virtual objects may include one or more of: targets, portals, and/or gameplay objects; and/or
the method where the object data includes data on user interactions with the virtual objects in the virtual-world environment; and/or
the method where the object data includes, for at least one object, data on whether the at least one object has been hit by the user in the virtual-world environment; and/or
the method where the first data also includes sensor data from at least one sensor being worn by the person, and where movements of the person are recognized in (b) also using the sensor data; and/or
the method where the sensor data may include physiological data of the person; and/or
the method where acts (a)-(e) are performed on a computer system remote from the user device; and/or
the method where the first data were sent to the computer system via a network; and/or
the method where the first data were sent to the computer system in real time, while the person was performing the actions and/or movements.

Implementations of the described techniques may include hardware, a method or process, or computer software on a computer-accessible medium.

A skilled reader will understand that any method described above or below and/or claimed and described as a sequence of steps or acts is not restrictive in the sense of the order of steps or acts.

Below is a list of method or process embodiments. Those will be indicated with a letter “P”. Whenever such embodiments are referred to, this will be done by referring to “P” embodiments.

P1. A computer-implemented method comprising:

(A) obtaining first data, said first data including:
(i) telemetry data from a user device, the telemetry data relating to actions and/or movements of a person wearing the user device in a real-world environment, wherein the user device comprises a virtual reality (VR) headset,
(iii) synchronization data, and
(iii) object data relating to one or more virtual objects in a virtual-world environment;

(B) analyzing the first data to recognize the actions and/or movements of the person in the real-world environment;

(C) mapping the actions and/or movements recognized in (B) of the person in the real-world environment to corresponding virtual actions and/or movements of a virtual person in the virtual world environment and relative to said virtual objects in the virtual world environment, said mapping using said synchronization data;

(D) rendering at least some of the virtual actions and/or movements of the virtual person in the virtual world environment relative to the virtual objects; and

(E) producing one or more video segments of the virtual person in the virtual world environment as rendered in (D).

P2. The method of embodiment P1, wherein the synchronization data correspond to beatmap data that was previously provided to the user device.
P3. The method of embodiments P1 or P2, wherein, in (C), the mapping uses the synchronization data to map the actions and/or movements to the beatmap data.
P4. The method of any of the preceding embodiments, wherein the one or more video segments comprise a video.
P5. The method of any of the preceding embodiments, wherein the one or more video segments are produced from a corresponding one or more arbitrary viewpoints in the virtual world environment.
P6. The method of any of the preceding embodiments, wherein the one or more video segments comprise a 360-video.
P7. The method of any of the preceding embodiments, wherein the first data are obtained in (A) while a first view of the virtual world environment is being displayed on a display of the VR headset.
P8. The method of embodiment(s) P7, wherein the first view is produced at a first resolution, and wherein the one or more video segments are at a resolution higher than the first resolution.
P9. The method of any of the preceding embodiments, wherein the telemetry data are produced by and sent from the VR headset.
P10. The method of any of the preceding embodiments, wherein the user device also comprises at least one VR handheld controller being worn by the person, and wherein the first data also includes data from the at least one VR handheld controller.
P11. The method of any of the preceding embodiments, wherein the virtual objects comprise objects in a game or activity.
P12. The method of any of the preceding embodiments, wherein the virtual objects comprise one or more of: targets, portals, and/or gameplay objects.
P13. The method of any of the preceding embodiments, wherein the object data includes data on user interactions with the virtual objects in the virtual-world environment.
P14. The method of any of the preceding embodiments, wherein the object data includes, for at least one object, data on whether the at least one object has been hit by the user in the virtual-world environment.
P15. The method of any of the preceding embodiments, wherein the first data also includes sensor data from at least one sensor being worn by the person, and wherein movements of the person are recognized in (B) also using the sensor data.
P16. The method of embodiment(s) P15, wherein the sensor data comprise physiological data of the person.
P17. The method of any of the preceding embodiments, wherein acts (A)-(E) are performed on a computer system remote from the user device.
P18. The method of any of the preceding embodiments, wherein the first data were sent to the computer system via a network.
P19. The method of any of the preceding embodiments, wherein the first data were sent to the computer system in real time, while the person was performing the actions and/or movements.

Below are device embodiments, indicated with a letter “D”.

D20. A device, comprising:
(a) hardware including memory and at least one processor, and
(b) a service running on the hardware, wherein the service is configured to:

perform the method of any of the method embodiments P1-P19.

Below is an article of manufacture embodiment, indicated with a letter “M”.

M21. An article of manufacture comprising non-transitory computer-readable media having computer-readable instructions stored thereon, the computer readable instructions including instructions for implementing a computer-implemented method, the method operable on a device comprising hardware including memory and at least one processor and running a service on the hardware, the method comprising the method of any one of the preceding method embodiments P1-P19.

Below is computer-readable recording medium embodiment, indicated with a letter “R”.
R22. A non-transitory computer-readable recording medium storing one or more programs, which, when executed, cause one or more processors to, at least: perform the method of any one of the preceding method embodiments P1-P19.

The above features, along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of a virtual reality system according to exemplary embodiments hereof;

FIG. 2 depicts aspects of a video production system according to exemplary embodiments hereof;

FIG. 3 depicts aspects of a mapping and transforming telemetry data according to exemplary embodiments hereof;

FIG. 4 is a flowchart of exemplary aspects hereof; and

FIG. 5 is a logical block diagram depicting aspects of a computer system.

### DETAILED DESCRIPTION OF THE PRESENTLY PREFERRED

### Exemplary Embodiments

Glossary and Abbreviations

As used herein, unless used otherwise, the following terms or abbreviations have the following meanings:

“AR” means augmented reality.

“VR” means virtual reality.

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### DESCRIPTION

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

It will be appreciated that variations to the foregoing embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

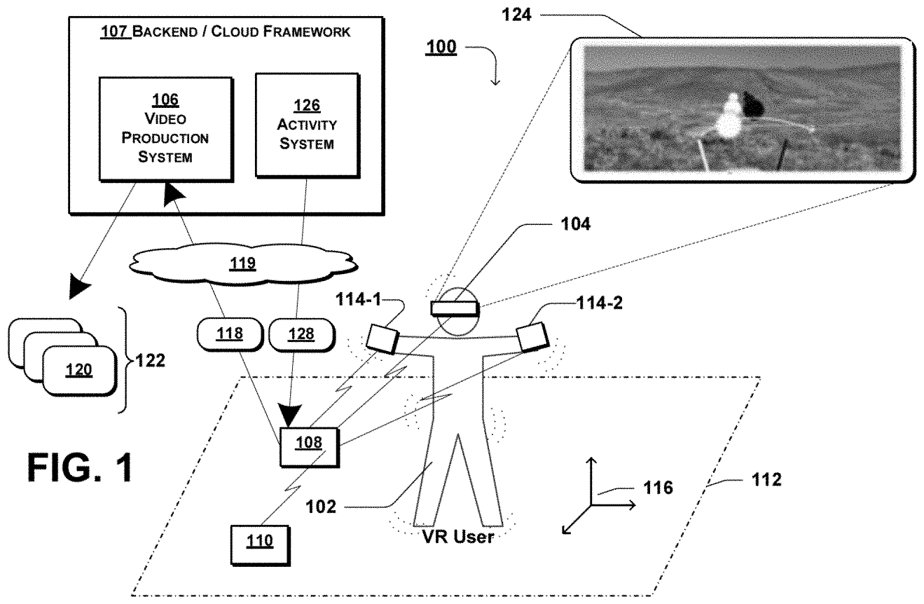

A system supporting a real-time virtual reality environment 100 is described now with reference now to FIG. 1, in which a person (VR user) 102 in a real-world environment or space 112 uses a VR device or headset 104 to view and interact with/in a virtual environment. The VR headset 104 may be connected (wired and/or wirelessly) to a video production system 106, e.g., via an access point 108 (e.g., a Wi-Fi access point or the like). Since the user's activity may include a lot of movement, the VR headset 104 is preferably wirelessly connected to the access point 108. In some cases, the VR headset 104 may connect to the video production system 106 via a user device or computer system (not shown). While shown as a separate component, in some embodiments the access point 108 may be incorporated into the VR headset 104.

As used herein, the term “activity” may include any activity including, without limitation, any exercise or game, yoga, running, cycling, fencing, tennis, meditation, etc. An activity may or may not require movement, sound (e.g., speech), etc. An activity may include movement (or not) of the user's head, arms, hands, legs, feet, etc. The scope hereof is not limited by the kind of activity.

The video production system 106 may be part of backend/cloud framework 107.

Sensors (not shown in the drawings) in the VR headset 104 and/or other sensors 110 in the user's environment may track the VR user's actual movements (e.g., head movements, etc.) and other information. The VR headset 104 preferably provides user tracking without external sensors. In a presently preferred implementation, the VR headset 104 is an Oculus Quest headset made by Facebook Technologies, LLC.

Tracking or telemetry data from the VR headset 104 may be provided in real-time (as all or part of data 118) to the video production system 106.

Similarly, data from the sensor(s) 110 may also be provided to the video production system 106 (e.g., via the access point 108).

The user 102 may also have one or two handheld devices 114-1, 114-2 (collectively handheld device(s) and/or controller(s) 114) (e.g., Oculus Touch Controllers). Hand movement information from the handheld controller(s) 114 may be provided with the data 118 to the video production system 106 (e.g., via the access point 108).

In some embodiments, hand movement information from the handheld controller(s) 114 may be provided to the VR headset 104 or to another computing device which may then provide that information to the video production system 106. In such cases, the handheld controller(s) 114 may communicate wirelessly with the VR headset 104.

The VR headset 104 presents the VR user 102 with a view 124 corresponding to that VR user's virtual or augmented environment.

Preferably, the view 124 of the VR user's virtual environment is shown as if seen from the location, perspective, and orientation of the VR user 102. The VR user's view 124 may be provided as a VR view or as an augmented view (e.g., an AR view).

In some embodiments, the user 102 may perform an activity such as a game or the like in the VR user's virtual environment. The backend/cloud framework 107 may include an activity system 126 that may provide game information to the VR headset 104. In presently preferred embodiments, the activity system 126 may provide so-called beat map and/or other information 128 to the headset (e.g., via the network 119 and the access point 108).

As the user progresses through an activity, the VR headset 104 may store information about the position and orientation of VR headset 104 and of the controllers 114 for the user's left and right hands. In a present implementation, the user's activity (and the beatmap) is divided into sections (e.g., 20 second sections), and the information is collected and stored at a high frequency (e.g., 72 Hz) within a section. The VR headset 104 may also store information about the location of targets, portals and all gameplay objects that are temporally variant, where they are in space, whether any have been hit, etc. at the same or similar frequency. This collected information allows the video production system to recreate a gameplay scene at any moment in time in the space of that section.

This collected information may then be sent to the video production system 106, preferably in the background, as all or part of data 118, as the user's activity/workout continues, and several of these sections may be sent to the video production system 106 over the course of an activity/workout. The data 118 that are provided to the video production system 106 preferably include beatmap information.

The Video Production System

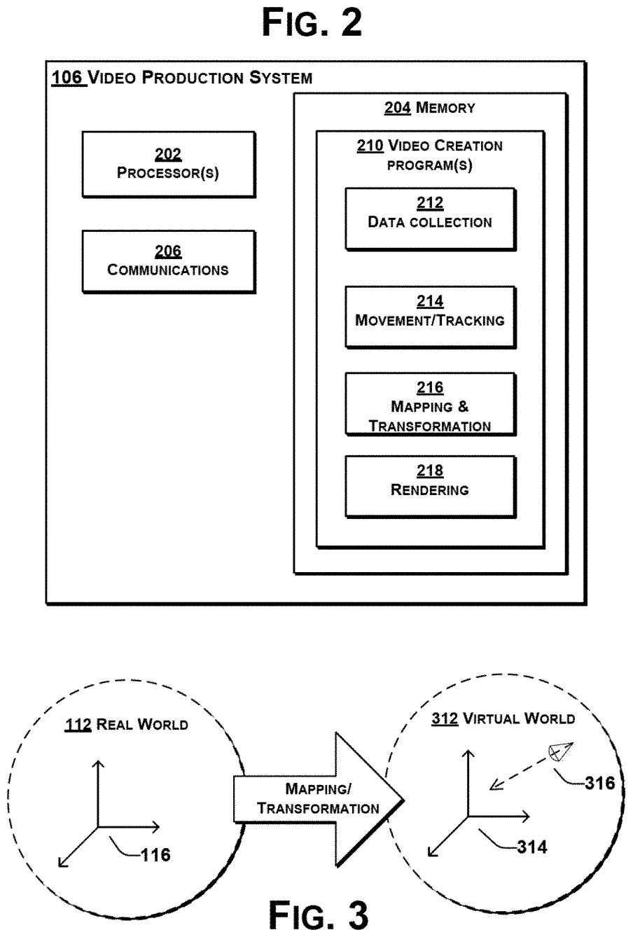

With reference to FIG. 2, the video production system 106 is a computer system (as discussed below), e.g., one or more servers, with processor(s) 202, memory 204, communication mechanisms 206, etc. One or more video creation programs 210 run on the video production system 106. The video creation programs 210 may store data in and retrieve data from one or more databases (not shown).

Although only one user 102 is shown in FIG. 1, it should be appreciated that the video production system 106 may interact with multiple users at the same time. It should also be appreciated that the following description of the operation of the video production system 106 with one user extends to multiple users.

The video creation programs 210 of the video production system 106 may include data collection mechanism(s) 212, movement/tracking mechanism(s) 214, mapping and transformation mechanism(s) 216, and rendering and production mechanism(s) 218.

In operation, the data collection mechanism(s) 212 obtain data 118 (FIG. 1) from a user (e.g., user 102 in FIG. 1). The data 118 may include at least some of user movement/telemetry data, information about the location of targets, portals and all gameplay objects that are temporally variant, where they are in space, whether any have been hit, etc.

The video production system 106 may make decisions on whether a given section should be rendered to video based on various criteria (e.g., did the player hit a lot of targets in that capture, etc.).

The movement/tracking mechanism(s) 214 determines or approximates, from that data, the user's actual movements in the user's real-world space 112. The user's movements may be given relative to a 3-D coordinate system 116 the user's real-world space 112. If the data 118 includes data from the user's handheld controller(s) 114, the movement/tracking mechanism(s) 214 may also determine movement of one or both of the user's hands in the user's real-world space 112. In some cases, the user's headset 104 may provide the user's actual 3-D coordinates in the real-world space 112.

The movement/tracking mechanism(s) 214 may determine or extrapolate aspects of the user's movement based on machine learning (ML) or other models of user movement. For example, a machine learning mechanism may be trained to recognize certain movements and/or types of movements and may then be used to recognize those movements based on the data 118 provided by the user 102.

The movement/tracking mechanism(s) 214 may use information provided to the video production system 106 with the data 118 (e.g., beatmap information) to synchronize the user's movements with beatmap information 128 that was sent to the user 102.

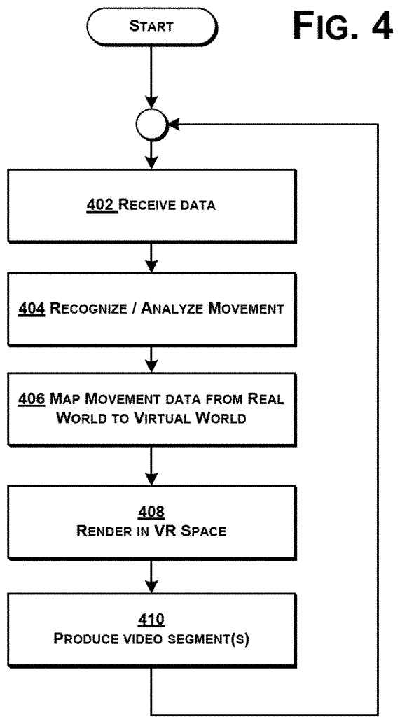

With reference to FIG. 3, the mapping and transformation mechanism(s) 216 may take the movement/tracking data (as determined by the movement/tracking mechanism(s) 214), and transform those data from the real-world coordinate system 116 in the user's real-world space 112 to corresponding 3-D coordinates in a virtual-world coordinate system 314 in a virtual world 312.

Those of skill in the art will understand, upon reading this description, that the mapping and transformation mechanism(s) 216 may operate prior to or in conjunction with the movement/tracking mechanism(s) 214. As with all mechanisms described herein, the logical boundaries are used to aid the description and are not intended to limit the scope hereof.

For the sake of this description, the user's movement data in the real-world space 112 are referred to as the user's real-world movement data, and the user's movement data in the virtual-world space 312 are referred to as the user's virtual movement data.

As should be appreciated, the video production system 106 may use the provided information and improve the representation in various ways. For example, the video production system 106 may use the user's head and/or hand positions to infer the whole body position of the player.

The rendering and production mechanism(s) 218 use the user's virtual movement data (produced as described above) and then renders or produces one or more video segments or sequences 120 of the user (or an avatar or the like corresponding to the user) in the virtual world 312. The video sequences may be from any arbitrary viewpoint(s) 316 in the virtual world 312.

In some embodiments, the video production system 106 may also receive or have other user data (e.g., physiological data or the like) and may use some of the physiological data (e.g., heartrate, temperature, sweat level, breathing rate, etc.) to determine the user's movements and actions in the virtual space.

The one or more video sequences 120 produced by the rendering and production mechanism(s) 218 may be provided to the user or to other users. The one or more video sequences 120 may also be referred to as video sequence(s) 120 or video 122.

As should be appreciated, the compute power that may be used by the video production system 106 may far exceed that of the headset 104 or of a computing device that the user may have. Thus, the resolution and overall quality of the video sequence(s) 120 may exceed that produced by the headset 104 of the view 124 corresponding to that VR user's virtual or augmented environment.

As noted, the video sequence(s) 120 may be from any arbitrary viewpoint 316 in the virtual world 312. Multiple distinct and arbitrary viewpoints 316 may be used, and, in some embodiments, the video production system 106 may produce a 360-degree video of the user's actions in the VR user's virtual or augmented environment. Those of skill in the art will understand, upon reading this description, that the more complex the user's virtual or augmented environment, and the more viewpoints included, the longer it will take to produce the video sequence(s) 120.

The rendering and production mechanism(s) 218 may also include various post-processing operations, e.g., to provide visual effects to the rendered video. For example, the rendering and production mechanism(s) 218 may show some aspects of the rendered video at a different speed (e.g., in slow motion) and/or enhanced.

The video production system 106 may be co-located with the user (e.g., in the same room), or it may be fully or wholly located elsewhere. For example, the video production system 106 may be located at a location distinct from the user, in which case the user's data 118 may be sent to the video production system 106 via a network 119 (e.g., the Internet). Although in preferred cases the user's data 118 are provided to the video production system 106 as the data are generated (i.e., in real-time), in some cases, the user's data 118 may be collected and stored at the user's location, and then sent to the video production system 106. When located apart from the user, and accessed via a network, the video production system 106 may be considered to be a cloud-based system.

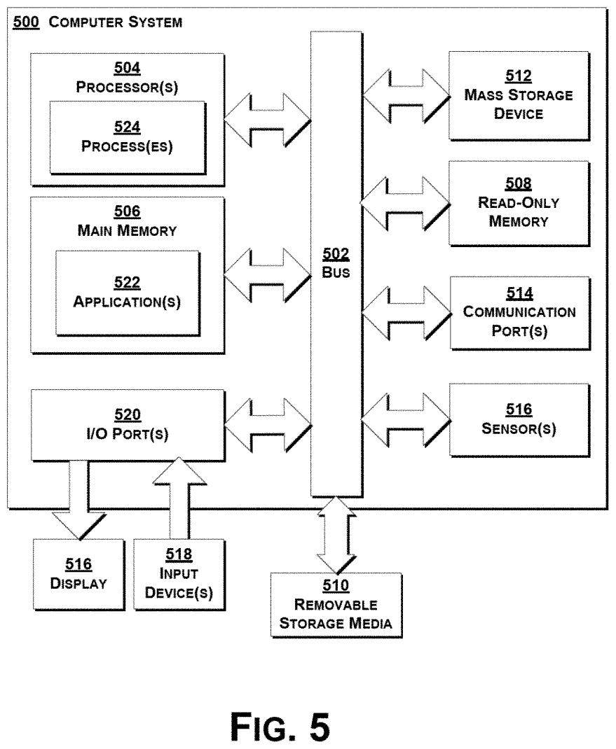

FIG. 4 is a flowchart of exemplary aspects of the video production system 106.

The example described here excludes the setup of the user's device and linking the headset to the user device to the video production system 106. These may be done in any suitable manner and may depend on the kind of headset, device, network connections, etc. For the sake of this example description, it may be assumed that the user's headset and other devices are connected to the video production system 106.

With reference to FIGS. 1-4, the user begins their activity, and their headset 104 (and handheld device(s)/controller(s) 114, if used) provide movement data as user data 118 to the data collection mechanism(s) 212. Other data, e.g., from external sensors 110 and from the user's physiological sensors (not shown) may also be provided as part of the movement/telemetry data 118.

While the activity is going on at the user's end, and the user's movement data 118 are being sent to the video production system 106, the data collection mechanism(s) 212 on the video production system 106 continuously receive and collect user data 118 from the user (at 402).

The collected data are analyzed (at 406, by the movement/tracking mechanism(s) 214) to try to recognize, track, and analyze the user's movement. The movement data determined (at 404) by the movement/tracking mechanism(s) 214 are then mapped and/or transformed (at 406) by the mapping and transformation mechanism(s) 216 to map from the coordinate system 116 of user's real world 112 to the virtual coordinate system 314 of the virtual world 312. As noted above, the transformation to the virtual coordinate system 314 may take place as part of or before the recognition and analysis. The system may synchronize with beatmap data (provided to the video production system 106 as part of user data 118).

The user movement data in the virtual coordinate system 314 are then rendered (at 408) by rendering and production mechanism(s) 218 to produce (at 410) a video 122 comprising one or more video segments or sequences 120. The video 122 may be from one or more arbitrary viewpoints 316, or it may be or include a 360-video. The video may use the beatmap data.

In some cases, the system may defer the rendering until the user stops sending data.

While the user is sending movement and other data to the video production system 106, the user's headset 104 is preferably showing the user a view 124 of the user in the virtual world 312. However, as noted above, the view 124 that the user sees in real-time is from their point of view, and the view 124 shown in the virtual world will have a lower resolution and possibly less accurate movement that the view(s) produced by the video production system 106. Those of skill in the art will understand, upon reading this description, that the increased compute power of the video production system 106, means that it can produce higher quality videos. The higher quality video sequences 120 may have higher video resolution, more accurate movement depiction, and more VR or AR features and/or interactions.

In some cases, the video production system 106 produces the video sequences 120 in real-time. In other cases, the video production system 106 may collect data for subsequent production of the video sequences 120.

In some embodiments the video production system 106 may use inverse kinematics (IK) techniques and an IK character rig to solve the users position and recreate the scene. Those of skill in the art will understand, upon reading this description, that the use of IK may provide a more accurate and/or convincing rendering of the user in the virtual space. It should be appreciated, however, that any representation of the data and the user may be used.

Real Time

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time computation may refer to an online computation, i.e., a computation that produces its answer(s) as data arrive, and generally keeps up with continuously arriving data. The term “online” computation is compared to an “offline” or “batch” computation.

Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 5 is a schematic diagram of a computer system 500 upon which embodiments of the present disclosure may be implemented and carried out.

According to the present example, the computer system 500 includes a bus 502 (i.e., interconnect), one or more processors 504, a main memory 506, read-only memory 508, removable storage media 510, mass storage 512, and one or more communications ports 514. Communication port(s) 514 may be connected to one or more networks (not shown) by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an Ethernet port, a Gigabit port using copper or fiber, or a USB port, and the like. Communications port(s) 514 may be chosen depending on a network such as a Local Area Network (LAN), a Wide Area Network (WAN), or any network to which the computer system 500 connects. The computer system 500 may be in communication with peripheral devices (e.g., display screen 516, input device(s) 518) via Input/Output (I/O) port 520.

Main memory 506 can be Random Access Memory (RAM), or any other dynamic storage device(s) commonly known in the art. Read-only memory (ROM) 508 can be any static storage device(s) such as Programmable Read-Only Memory (PROM) chips for storing static information such as instructions for processor(s) 504. Mass storage 512 can be used to store information and instructions. For example, hard disk drives, an optical disc, an array of disks such as Redundant Array of Independent Disks (RAID), or any other mass storage devices may be used.

Bus 502 communicatively couples processor(s) 504 with the other memory, storage, and communications blocks. Bus 502 can be a PCI/PCI-X, SCSI, a Universal Serial Bus (USB) based system bus (or other) depending on the storage devices used, and the like. Removable storage media 510 can be any kind of external storage, including hard-drives, floppy drives, USB drives, Compact Disc-Read Only Memory (CD-ROM), Compact Disc—Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radfrequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 506 is encoded with application(s) 522 that support(s) the functionality as discussed herein (the application(s) 522 may be an application(s) that provides some or all of the functionality of the services/mechanisms described herein, e.g., VR sharing application 230, FIG. 2). Application(s) 522 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret, or otherwise perform the logic instructions of the application(s) 522. Execution of application(s) 522 produces processing functionality of the service related to the application(s). In other words, the process(es) 524 represent one or more portions of the application(s) 522 performing within or upon the processor(s) 504 in the computer system 500.

For example, process(es) 524 may include an AR application process corresponding to VR sharing application 230.

It should be noted that, in addition to the process(es) 524 that carries(carry) out operations as discussed herein, other embodiments herein include the application(s) 522 itself (i.e., the un-executed or non-performing logic instructions and/or data). The application(s) 522 may be stored on a computer readable medium (e.g., a repository) such as a disk or in an optical medium. According to other embodiments, the application(s) 522 can also be stored in a memory type system such as in firmware, read only memory (ROM), or, as in this example, as executable code within the main memory 506 (e.g., within Random Access Memory or RAM). For example, application(s) 522 may also be stored in removable storage media 510, read-only memory 508, and/or mass storage device 512.

Those skilled in the art will understand that the computer system 500 can include other processes and/or software and hardware components, such as an operating system that controls allocation and use of hardware resources.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs,” and includes the case of only one ABC.

The term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used in this description, the term “portion” means some or all. So, for example, “A portion of X” may include some of “X” or all of “X.” In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only,” the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a),” “(b),” and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise,” “including”, “having”, and “contain” and their variations should be understood as meaning “including but not limited to” and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A computer-implemented method comprising:
(A) obtaining first data, said first data including:
(i) telemetry data from a user device, the telemetry data relating to actions and/or movements of a person wearing the user device in a real-world environment, wherein the user device comprises a virtual reality (VR) headset,
(iii) synchronization data, and
(iii) object data relating to one or more virtual objects in a virtual-world environment;
(B) analyzing the first data to recognize the actions and/or movements of the person in the real-world environment;
(C) mapping the actions and/or movements recognized in (B) of the person in the real-world environment to corresponding virtual actions and/or movements of a virtual person in the virtual world environment and relative to said virtual objects in the virtual world environment, said mapping using said synchronization data;
(D) rendering at least some of the virtual actions and/or movements of the virtual person in the virtual world environment relative to the virtual objects; and
(E) producing one or more video segments of the virtual person in the virtual world environment as rendered in (D).

2. The method of claim 1, wherein the synchronization data correspond to beatmap data that was previously provided to the user device.

3. The method of claim 1, wherein, in (C), the mapping uses the synchronization data to map the actions and/or movements to the beatmap data.

4. The method of claim 1, wherein the one or more video segments comprise a video.

5. The method of claim 1, wherein the one or more video segments are produced from a corresponding one or more arbitrary viewpoints in the virtual world environment.

6. The method of claim 1, wherein the one or more video segments comprise a 360-video.

7. The method of any claim 1, wherein the first data are obtained in (A) while a first view of the virtual world environment is being displayed on a display of the VR headset.

8. The method of claim 7, wherein the first view is produced at a first resolution, and wherein the one or more video segments are at a resolution higher than the first resolution.

9. The method of claim 1, wherein the telemetry data are produced by and sent from the VR headset.

10. The method of claim 1, wherein the user device also comprises at least one VR handheld controller being worn by the person, and wherein the first data also includes data from the at least one VR handheld controller.

11. The method of claim 1, wherein the virtual objects comprise objects in a game or activity.

12. The method of claim 1, wherein the virtual objects comprise one or more of: targets, portals, and/or gameplay objects.

13. The method of claim 1, wherein the object data includes data on user interactions with the virtual objects in the virtual-world environment.

14. The method of claim 1, wherein the object data includes, for at least one object, data on whether the at least one object has been hit by the user in the virtual-world environment.

15. The method of claim 1, wherein the first data also includes sensor data from at least one sensor being worn by the person, and wherein movements of the person are recognized in (B) also using the sensor data.

16. The method of claim 15, wherein the sensor data comprise physiological data of the person.

17. The method of claim 1, wherein acts (A)-(E) are performed on a computer system remote from the user device.

18. The method of claim 17, wherein the first data were sent to the computer system via a network.

19. The method of claim 17, wherein the first data were sent to the computer system in real time, while the person was performing the actions and/or movements.

20. A device, comprising:
(a) hardware including memory and at least one processor, and
(b) a service running on said hardware, wherein said service is configured to perform the method of claim 1.

21. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 1.

22. A non-transitory computer-readable recording medium storing one or more programs, which, when executed, cause one or more processors to, at least: perform the method of claim 1.
